(19) United States
(12) Patent Application Publication
(10) Pub. No.: US 2008/0065787 A1
(43) Pub. Date: Mar. 13, 2008

(54) Method for operating host in hot key way in centralized computer system

(75) Inventors: Te-Hsien Lai, Taipei Shien (TW); Pi-Cheng Chen, Taipei Shien (TW); Ming-Chien Yang, Taipei Shien (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/878,396

(22) Filed: Jul. 24, 2007

(30) Foreign Application Priority Data
Sep. 8, 2006 (TW) 095133371

(51) Int. Cl. G06F 3/01

(52) U.S. Cl. 710/5

(57) ABSTRACT

The invention is to provide a centralized computer system, i.e., so-called blade PC system. The centralized computer system according to the invention includes a plurality of centralized and bladed hosts. In particularly, the centralized computer system according to the invention enables a set of I/O peripherals to operate a host or a host switch connecting with the host to execute specific functions in a hot key way.

### BACKGROUND OF THE INVENTION

1. Field of the Invention

The invention relates to a centralized computer system, i.e., the so-called blade PC system and, more particularly, to a control method for enabling a set of I/O peripherals to operate a host or a host switch connecting with the host to execute specific functions in a hot key way.

2. Description of the Prior Art

Many commercial businesses and enterprises make extensive use of personal computers (PCs) in their daily operations. In a typical manner, each user of a PC in the enterprise has a networked PC at his/her desk or in the working area. As the number of networked computer systems utilized in an enterprise increases, the management of resources in the network may become increasingly complex and expensive. Therefore, some of the manageable issues involved in maintaining a large number of networked computer systems are required to be taken into consideration including the ease of installation and deployment, the topology and physical logistics of the network, asset management, scalability (the cost and effort involved in increasing the number of units), troubleshooting network or unit problems, support costs, software tracking and management, the issue of physical space such as space of the floor space or room on the desk, as well as security issues regarding physical assets, information protection, software control, and computer viruses.

To overcome the mentioned-above problems, many IT companies have developed the centralized computer systems. Referring to FIG. 1, FIG. 1 is a schematic diagram illustrating an infrastructure of a typical centralized computer system 1. As shown in FIG. 1, the centralized computer system 1 includes a plurality of hosts 12, where each host 12 is equipped with and operated by a set of peripherals 14 including at least one peripheral device. The hosts 12 in the centralized computer system 1 are bladed, i.e., each of the hosts 12 is implemented into a “card”. In other words, each host 12 comprised on a circuit card includes the components of the standard computer system. The centralized computer system 1 also includes a network 16 to provide the hosts 12 to communicate with the remote peripheral devices. As shown in FIG. 1, each set of peripherals 14 may include a display 142, a keyboard 144, a mouse 146, and/or other peripheral devices for human interface. The centralized computer system 1 communicates with one set of peripherals 14 coupled to the host 12 by sending and receiving encoded I/O signals transmitted via the network 16. In general, a host switch (not shown in FIG. 1), connecting with the I/O interface of a host 12 in the centralized computer system 1. Relatively, each set of I/O peripherals 14 is equipped with a peripheral switch 148 coupled to all of the peripheral devices of the set of I/O peripherals 14. And, the I/O signals transmitted between one host 12 and the assigned set of I/O peripherals 14 are encoded and decoded by the corresponding host switch and the corresponding peripheral switch 148, transmitted via the network 16. The network 16 may be a Local Area Network (LAN), such as an intranet, or a Wide Area Network (WAN), such as the Internet, although other networks are taken into account.

On summary, the distinct features and advantages of the typical centralized computer system as follows:
(a) the centralized computer system can includes at least ten hosts in a chassis;
(b) because the hosts are bladed to reduce the volume, more hosts can be configure;
(c) because the centralized computer system is a highly integrated system, providing a management host to control and search the whole system is necessary;
(d) the hosts are centralized in the computer room to prevent man-made destruction and information stealing;
(e) by means of the setting of certain software, the user can read and retreat data but copy;
(f) because the hosts are centralized in the computer room, the user won't hear the noise generated by fans;
(g) with the centralized computer system, there are only a keyboard, a mouse, a display and a network connector on the user's desk, i.e., the user has more spatial usability;
(h) with the centralized computer system, two sets of I/O peripherals are enabled to operate the same host;
(i) with the centralized computer system, the manager can seamlessly monitor other hosts without being found out by other users; and
(j) with the centralized computer system, seamlessly broadcasting to all users is much easier.

However, the solutions for enabling a set of I/O peripherals to execute functions provided by a look-up table to operate a host or a host switch by specific key signals nowadays all need to utilize a software-driven way. That is to say, the host being operated needs to install software before the set of I/O peripherals is being used to operate the host. Furthermore, all procedures have to be operated under the operating system (OS). Moreover, the operating functions are operable only when the software is being executed.

Accordingly, one scope of the invention is to provide a centralized computer system utilizing a hot key way instead of a software-driven way to enable one set of I/O peripherals to operate a host or a host switch connecting with the host to execute specific functions.

### SUMMARY OF THE INVENTION

The invention is to provide a controlling method for a centralized computer system. The centralized computer system comprises a network, a host, a host switch connecting with the host and linking to the network, a peripheral switch linking to the network, and a set of I/O peripherals connecting with the peripheral switch. The host or the host switch is capable of executing a plurality of functions. The host switch comprises a look-up table for storing a plurality of first sets of key signals and a plurality of instructions which each corresponds to one of the first sets of key signals and represents execution of one of the functions. The control method utilizes the set of I/O peripherals to operate the host.

According to the control method of the invention for the centralized computer system, first, by use of the host switch and the peripheral switch, I/O signals transmitted between the host and the set of I/O peripherals are encoded and decoded, and then the decoded I/O signals are transmitted via the network. Afterward, at the host switch, it is judged if a second set of key signals, decoded from the decoded I/O signals transmitted from the peripheral switch, matches one of the first sets of key signals stored in the look-up table, and if any, the host or the host switch is driven to execute the function whose representative instruction corresponds to the first set of key signals matching the second set of key signals.

Additionally, the invention is to provide a centralized computer system comprising a network, a host, a host switch, a peripheral switch, and a set of I/O peripherals. The host switch connects with the host and links to the network. The host switch comprises a look-up table for storing a plurality of first sets of key signals and a plurality of instructions. Each instruction corresponds to one of the first sets of key signals and represents execution of one of the functions, wherein the host or the host switch is capable of executing these functions. The peripheral switch links to the network. The set of I/O peripherals electrically connects with the peripheral switch and operates the host, wherein I/O signals transmitted between the host and the set of I/O peripherals are encoded and decoded by the host switch and the peripheral switch, and then the decoded I/O signals are transmitted via the network. The host switch also judges if a second set of key signals, decoded from the decoded I/O signals transmitted from the peripheral switch, matches one of the first sets of key signals stored in the look-up table, and if any, the host or the host switch is driven to execute the function whose representative instruction corresponds to the first set of key signals matching the second set of key signals.

The advantage and spirit of the invention may be understood by the following recitations together with the appended drawings.

### BRIEF DESCRIPTION OF THE APPENDED DRAWINGS

FIG. 1 is a schematic diagram illustrating an infrastructure of a typical centralized computer system;

FIG. 2 is a schematic diagram illustrating an infrastructure of a centralized computer system according to a preferred embodiment of the invention;

FIG. 3A is a schematic diagram illustrating a partial infrastructure of a centralized computer system shown in FIG. 2 to illustrate the comparison between input signals in a processing module and a look-up table; and

FIG. 3B is a schematic diagram illustrating a portion of the look-up table shown in FIG. 3A.

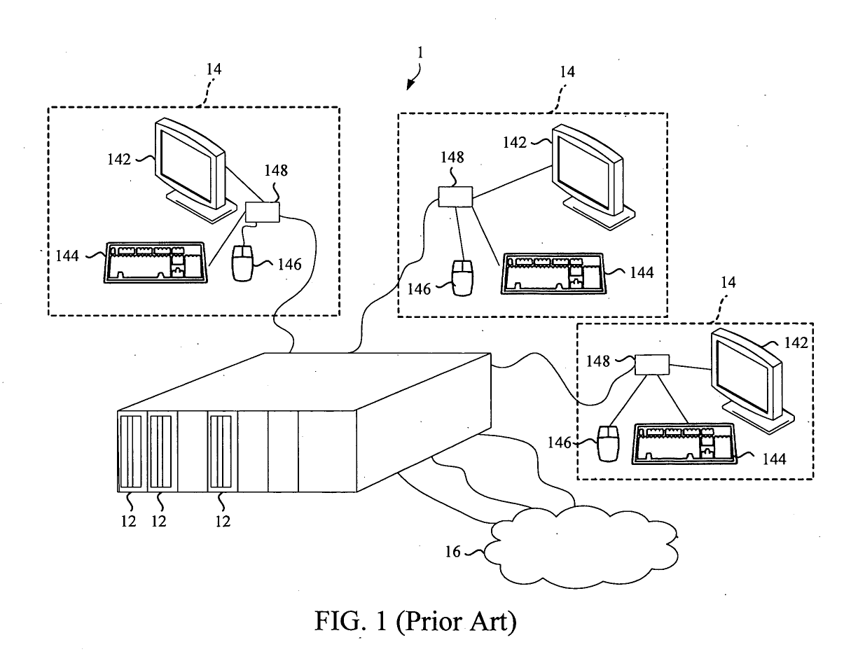

### DETAILED DESCRIPTION OF THE INVENTION

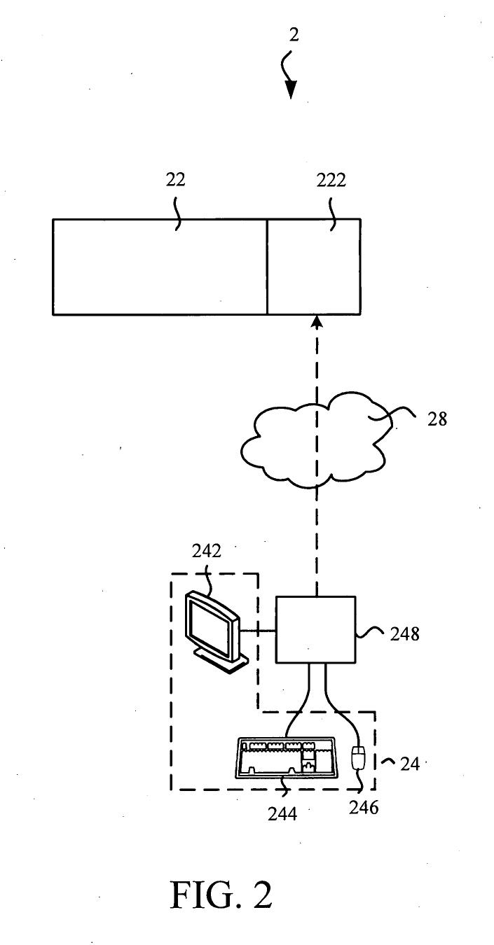

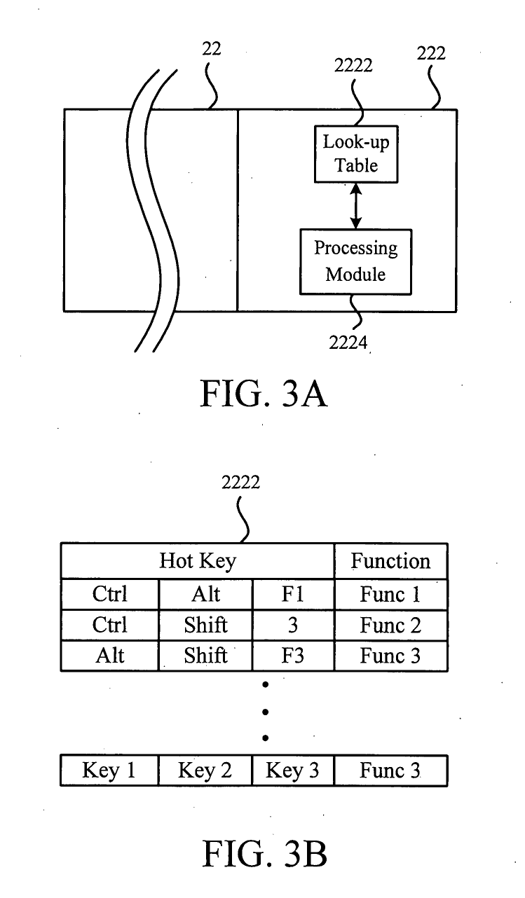

The invention is to provide a centralized computer system and a controlling method thereof and, more particularly, the invention utilizes a hot key way instead of a software-driven way to enable a set of peripherals to operate a host or a host switch connecting with the host to execute specific functions. By the descriptions of the preferred embodiments of the invention in the following, the features, spirits, advantages, and convenience of the implement are illustrated adequately. Referring to FIG. 2, FIG. 2 is a schematic diagram illustrating an infrastructure of a centralized computer system 2 according to a preferred embodiment of the invention. As shown in FIG. 2, the centralized computer system 2 comprises a network 28, a host 22, a host switch 222, a peripheral switch 248, and a set of I/O peripherals 24. The host switch 222 connects with the host 22 and links to the network 28. Afterward, referring to FIG. 3A, FIG. 3A is a schematic diagram illustrating a partial infrastructure of the centralized computer system 2 shown in FIG. 2, so as to illustrate the comparison between input signals in a processing module 2224 and a look-up table 2222. As shown in FIG. 3A, the host switch 222 comprises the look-up table 2222 for storing a plurality of first sets of key signals and a plurality of instructions. Referring to FIG. 3B, FIG. 3B is a schematic diagram illustrating parts of the look-up table 2222 shown in FIG. 3A. As shown in FIG. 3B, each of the instructions corresponds to one of the first sets of key signals and represents execution of one of a plurality of functions, wherein the host 22 or the host switch 222 is capable of executing the functions. The peripheral switch 248 links to the network 28. The first set of I/O peripherals 24 electrically connects with the peripheral switch 248. The first set of I/O peripherals 24 is assigned to operate the host 22.

As shown in FIG. 2, the first set of I/O peripherals 24 comprises a display 242 and M I/O devices, such as a keyboard 244, a mouse 246, and the like, wherein M is a natural number.

As shown in FIG. 2, the I/O signals transmitted between the host 22 and the first set of I/O peripherals 24 are encoded and decoded by the use of the host switch 222 and the peripheral switch 248, and then the decoded I/O signals are transmitted via the network 28.

As shown in FIG. 3A, the host switch 222 also judges if a second set of key signals matches one of the first sets of key signals stored in the look-up table 2222, and if any, the host 22 or the host switch 222 is driven to execute the function whose representative instruction corresponds to the first set of key signals matching the second set of key signals.

To achieve optimum quality of video or audio, when enough network bandwidth is provided, the frequency of retrieving data and the quality of video or audio can be improved. Namely, a better quantization table can be used to improve the quality of video quality and/or a lower compression ratio can be used to improve the quality of audio. Similarly, when enough network bandwidth is not provided, the frequency of retrieving data and the quality of video or audio should be accepted or rejected. Namely, a worse quantization table can be used to debase the quality of video and/or a higher compression ratio can be used to debase the quality of audio, so as to achieve operating requirement under narrow bandwidth. Therefore, in this embodiment, the functions comprise one selected from the group consisting of an image-capturing frequency setting function regarding a video signal of the I/O signals, a bit rate setting function regarding the video signal of the I/O signals, a bandwidth allocation function, an A/V sync control function, and a bit rate setting function regarding an audio output signal of the I/O signals.

Afterward, according to a preferred embodiment of the invention, a control method for the centralized computer system 2 will be illustrated. The infrastructure related to the centralized computer system 2 is illustrated in FIG. 2 and the corresponding description thereof, so the related description is not described here.

According to the control method of the invention for the centralized computer system 2, first, the host switch 222 and the peripheral switch 248 are utilized to encode and decode the I/O signals, transmitted between the host 22 and the first set of I/O peripherals 24, and then the decoded I/O signals are transmitted via the network 28.

Afterward, at the host switch 222, it is judged if a second set of key signals, decoded from the decoded I/O signals transmitted from the peripheral switch 248, matches one of the first sets of key signals stored in the look-up table 2222, and if any, the host 22 or the host switch 222 is driven to execute the function whose representative instruction corresponds to the first set of key signals matching the second set of key signals.

Compared to the prior art, obviously, according to the centralized computer system 2 and the control method thereof, the invention enables the set of I/O peripherals 24 to operate the host 22 or the host switch 222 connecting with the host 22 to execute specific functions in a hot key way, so as to avoid the inconvenience of the software-driven way.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A control method for a centralized computer system, the centralized computer system comprising a network, a host, a host switch connecting with the host and linking to the network, a peripheral switch linking to the network, and a set of I/O peripherals connecting with the peripheral switch, the host or the host switch being capable of executing a plurality of functions, the host switch comprising a look-up table for storing a plurality of first sets of key signals and a plurality of instructions which each corresponds to one of the plurality of first sets of key signals and represents execution of one of the functions, the control method, for enabling the set of I/O peripherals to operate the host, comprising the steps of:
by use of the host switch and the peripheral switch, encoding and decoding I/O signals transmitted between the host and the set of I/O peripherals, and transmitting the decoded I/O signals via the network; and
at the host switch, judging if a second set of key signals, decoded from the decoded I/O signals transmitted from the peripheral switch, matches one of the first sets of key signals stored in the look-up table, and if any, driving the host or the host switch to execute the function whose representative instruction corresponds to the first set of key signals matching the second set of key signals.

2. The control method of claim 1, wherein the functions comprise one selected from the group consisting of an image-capturing frequency setting function regarding a video signal of the I/O signals, a bit rate setting function regarding the video signal of the I/O signals, a bandwidth allocation function, an A/V sync control function, and a bit rate setting function regarding an audio output signal of the I/O signals.

3. A centralized computer system, comprising:
a network;
a host;
a host switch, connecting with the host and linking to the network, the host switch comprising a look-up table for storing a plurality of first sets of key signals and a plurality of instructions which each corresponds to one of the first sets of key signals and represents execution of one of the functions, wherein the host or the host switch being capable of executing the functions;
a peripheral switch linking to the network; and
a set of I/O peripherals electrically connecting with the peripheral switch and being assigned to operate the host;
wherein I/O signals transmitted between the host and the set of I/O peripherals are encoded and decoded by the host switch and the peripheral switch, and the decoded I/O signals are transmitted via the network; and
wherein the host switch also judges if a second set of key signals, decoded from the decoded I/O signals transmitted from the peripheral switch, matches one of the first sets of key signals stored in the look-up table, and if any, drives the host or the host switch to execute the function whose representative instruction corresponds to the first set of key signals matching the second set of key signals.

4. The centralized computer system of claim 3, wherein the functions comprise one selected from the group consisting of an image-capturing frequency setting function regarding a video signal of the I/O signals, a bit rate setting function regarding the video signal of the I/O signals, a bandwidth allocation function, an A/V sync control function, and a bit rate setting function regarding an audio output signal of the I/O signals.
